(19) United States
(12) Patent Application Publication
(10) Pub. No.: US 2015/0258925 A1
(43) Pub. Date: Sep. 17, 2015

(54) DEVICE FOR ASSEMBLING REAR SEAT BACK ASSEMBLY

(71) Applicant: HYUNDAI DYMOS INCORPORATED, Seosan-si (KR)

(72) Inventor: Sung Chol AN, Hwaseong-si (KR)

(73) Assignee: HYUNDAI DYMOS INCORPORATED, Seosan-si (KR)

(21) Appl. No.: 14/724,161

(22) Filed: May 28, 2015

Related U.S. Application Data
(63) Continuation of application No. PCT/KR2013/010852, filed on Nov. 27, 2013.

(30) Foreign Application Priority Data
Nov. 28, 2012 (KR) 10-2012-0136441

(51) Int. Cl. B60N 2/68; F16C 11/04

(52) U.S. Cl. CPC B60N 2/682; F16C 11/04

(57) ABSTRACT

A device for assembling a rear seat back assembly includes a mounting bracket having an opening and a locking protrusion formed inside of the mounting bracket, and a locking pin extended from a rear seat back frame. In particular, the locking pin includes a dislodgement recess on its outer circumferential surface and the dislodgment recess passes the locking protrusion when they are aligned each other with predetermined positions. For example, during insertion into or disengagement from the mounting bracket at a predetermined angle, the disengagement groove site passes through the locking protrusion site without being hooked so as to be mountable onto or removable from the mounting bracket.

### CROSS-REFERENCE TO RELATED APPLICATIONS

This application is a continuation of International Application No. PCT/KR2013/010852, filed on Nov. 27, 2013, which claims the benefit of Korean Application 10-2012-0136441, filed on Nov. 28, 2012. The disclosures of the above applications are incorporated herein by reference.

### FIELD

The present disclosure relates to a rear seat back assembly, and more particularly, to a device for assembling a rear seat back assembly in which the angle a rear seat back frame is adjustable.

### BACKGROUND

The statements in this section merely provide background information related to the present disclosure and may not constitute prior art.

Generally, seats are provided in the interior of a vehicle in order to provide a smoother ride and improve convenience. Vehicle seats are typically divided into a bucket seat and a bench seat.

Bucket seats are generally employed for the first line of seats of vehicles, i.e. the front seats of vehicles, and are individually configured and disposed for the driver and the passenger next to the driver. On the other hand, a bench seat is employed for the second line of seats of vehicles, i.e. the rear seats of vehicles, and forms the entire back seat as a unitary body.

In addition, the bench seat includes a seat cushion on which the buttocks of a passenger are seated, a seat back or a back of the seat, and a headrest fitted to the seat back. These components are mounted to the interior of vehicles in the position where they are separated.

FIG. 1 illustrates a related-art structure for mounting a seat back of a bench seat to the interior of a vehicle. The seat back-mounting structure includes a hinge pin 10, a compression plate 20, and a support bracket 30. The hinge pin 10 has a catch head 11 integrally formed on the distal end thereof, and is perpendicularly fixed to the frame of the seat back. The compression plate 20 is fitted around the hinge pin 10 such that the compression plate 20 can slide in the longitudinal direction while being elastically supported by the hinge pin 10. The support bracket 30 is fixed to a vehicle body. The support bracket 30 has a space section 31 in the central portion thereof and a cut section 32 that is communicably formed within the space section 31.

However, the above-described structure of the related art is intended to produce the coupling force of the hinge pin from the compressive force of the compression plate by simply inserting the hinge pin into the cut section of the support bracket. We have discovered that, since the coupling force of the hinge pin is weak, the seat back is not firmly mounted, which is problematic. In particular, since the compression plate compresses the support bracket using the elastic force of the spring, the operation of fitting or detaching the seat back to or from the vehicle is difficult.

### SUMMARY

The present disclosure provides a device for assembling a rear seat back assembly, in which the angle of a rear seat back frame is adjustable such that a rear seat back can be fitted to and detached from a wheel body in a simple and easy manner.

The present disclosure provides a device for assembling a rear seat back assembly including: a mounting bracket coupled to a vehicle body, wherein the mounting bracket has an opening in a side portion and a locking protrusion formed on an inner portion; and a locking pin protruding from one end of a rear seat back frame, wherein the locking pin has a dislodgement recess on an outer circumferential surface, wherein the dislodgement recess is able to pass by the locking protrusion such that no portion thereof is caught by the locking protrusion when the locking pin is fitted to or detached from the mounting bracket.

The locking protrusion may protrude from an inner portion of the mounting bracket. A fitting recess may be defined under the locking protrusion such that the locking pin is fitted into the fitting recess, the fitting recess having a size allowing the locking pin to be fitted into the fitting recess with the outer circumference of the locking pin being in surface contact with the fitting recess. The dislodgement recesses may be formed in a cut shape on at outer circumferential surface of the locking pin.

The mounting bracket may have an engagement recess formed in an inner portion. The locking pin may have an engagement flange on a distal end thereof, the engagement flange being configured to engage with the engagement recess.

The device may further include a mounting bush fitted on the locking pin, the mounting bush being disposed between the rear seat back frame and the mounting bracket.

According to the present disclosure, it is possible to insert or remove the locking pin into or from the mounting bracket by rotating the locking pin fixed to the rear seat back frame to a predetermined angle. It is therefore possible to fit or detach the rear seat back to or from the wheel body in a simple and easy manner, thereby improving the convenience of assembling the rear seat back.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a structure for assembling a rear seat back in the related art;

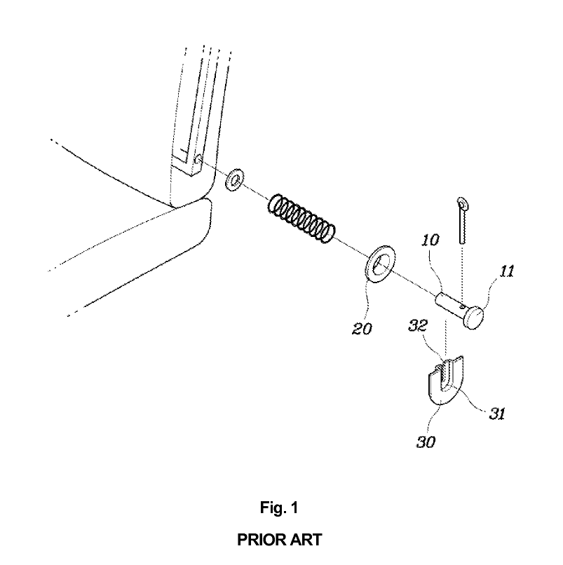

FIG. 2 is an enlarged view illustrating the overall configuration of a rear seat back assembly according to the present disclosure and a configuration in which a rear seat back frame is coupled to a mounting bracket;

FIG. 3 is an exploded view illustrating components for assembling in the rear seat back assembly according to the present disclosure;

FIG. 4 is a view illustrating a position where a locking pin according to the present disclosure is fitted into the mounting bracket at a predetermined angle of rotation; and

FIG. 5 is a view illustrating a position where the locking pin is rotated to an angle at which the locking pin is prevented from dislodging from the mounting bracket.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

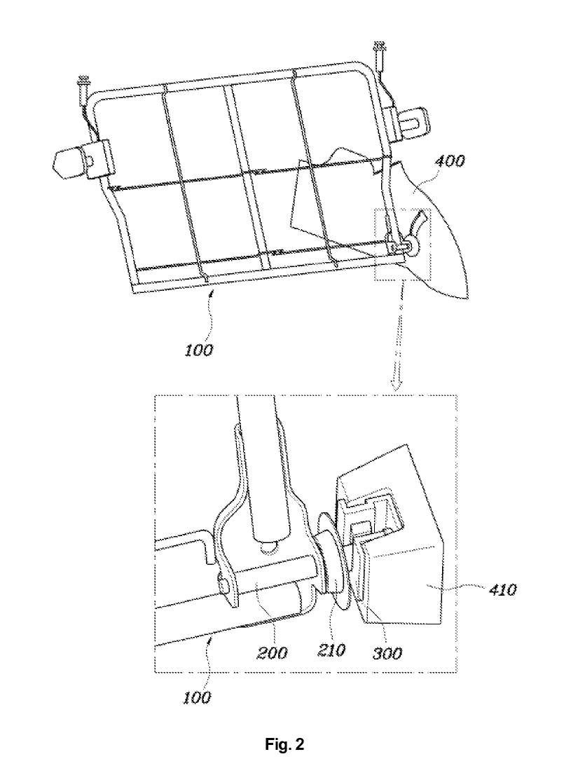

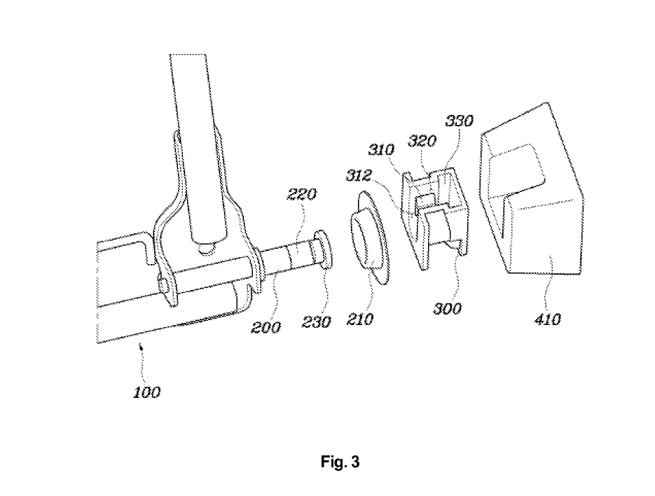

Referring to FIGS. 2 to 5, a device for assembling a rear seat back assembly according to the present disclosure includes a mounting bracket 300 and a locking pin 200. The mounting bracket 300 is coupled to a vehicle body 400, and has an opening in a side portion and locking protrusions 320 formed on inner portions. The locking pin 200 protrudes from one end of a rear seat back frame 100, and has dislodgement recesses 220 at outer circumferential portions at positions corresponding to the locking protrusions 320. With this configuration, when the locking pin 200 is inserted into or removed from the mounting bracket 300 at a predetermined angle, the dislodgement recesses 220 can pass between the locking protrusions 320 such that no portions thereof are caught by the locking protrusions 320. In this manner, the locking pin 200 can be fitted to or detached from the mounting bracket 300.

Specifically, the rear seat back assembly includes not only the rear seat back frame 100, but also the locking pin 200 coupled to the rear seat back frame 100 and the mounting bracket 300 fixed to the vehicle body 400.

Here, the mounting bracket 300 is fixedly mounted to the vehicle frame 400. A fixing bracket 410 helps the mounting bracket 300 be mounted to the vehicle frame 400. The fixing bracket 410 may be provided as a separate part. The fixing bracket 410 has a recess into which the mounting bracket 300 can be fitted.

The mounting bracket 300 has an upwardly open mounting recess 310 in the central portion thereof. A U-shaped support recess 312 is formed in one portion of the mounting recess 310. The support recess 312 is cut in the direction of the rear seat back frame 100. With this configuration, the locking pin 200 is inserted into and supported by the support recess 312.

In particular, the locking protrusions 320 protrude from both inner sides of the central portion of the mounting recess 310 such that the locking protrusions 320 face each other. This configuration allows the locking pin 200 to be inserted into and removed from the mounting bracket when the locking pin 200 is at a predetermined angle of rotation.

In addition, the locking pin 200 is disposed at the lower end of the rear seat back frame 100 such that the locking pin 200 protrudes toward the mounting bracket 300. The protruding end portion of the locking pin 200 is inserted into the mounting bracket 300 such that the locking pin 200 is rotatable with respect to the mounting bracket 300.

In particular, the dislodgement recesses 220 in the both outer circumferential portions of the locking pin 200 are cut by a width equal to the length by which the locking protrusions 320 protrude. With this configuration, when the locking pin 200 is inserted into or removed from the mounting bracket 300 at a predetermined angle, none of the dislodgement recesses 220 of the locking pin 200 are caught by the locking protrusions 320, whereby the locking pin 200 can be fitted to or detached from the mounting bracket 300.

In this case, the predetermined angle refers to the angle at which the thickness of the locking pin 200 having the dislodgement recesses 220 formed in both sides thereof is smaller than the distance between the locking protrusions 320.

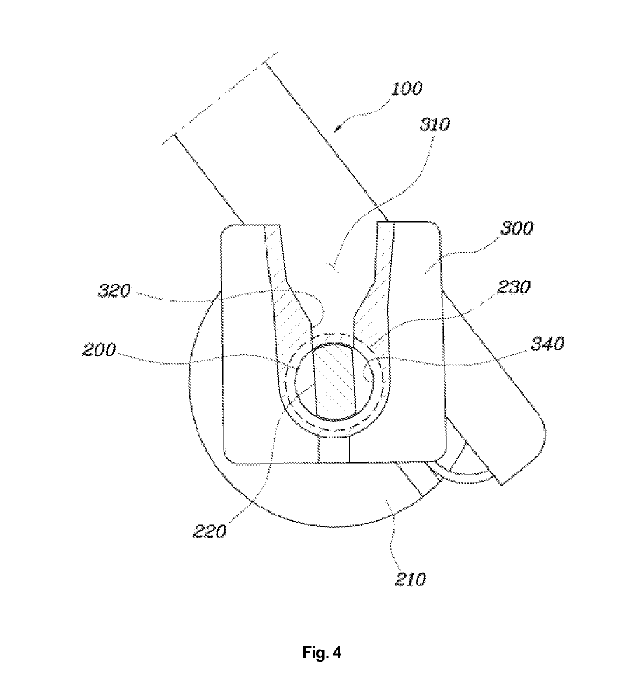

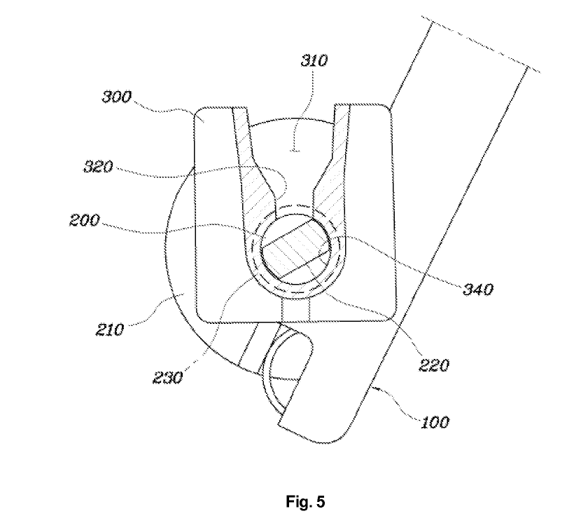

As illustrated in FIGS. 4 and 5, when the locking pin 200 fixed to the rear seat back frame 100 is fitted to the interior of the mounting bracket 300, the ability to insert the locking pin 200 is determined according to the angle of the locking pin 200. In detail, when the locking pin 200 is inserted into the mounting bracket 300, if the dislodgement recesses 220 of the locking pin 200 are not aligned with the locking protrusions 320, the outer circumference of the locking pin 200 is caught by the locking protrusions 320, such that the locking pin 200 cannot move to the lower portions of the locking protrusions 320. Consequently, the locking pin 200 cannot be fitted to the mounting bracket 300.

Here, when the dislodgement recesses 220 of the locking pin 200 are aligned with the locking protrusions 320 by rotating the locking pin 200, the thickness of the locking pin 200 is smaller than or equal to the distance between the locking protrusions 320 due to the cut shape of the dislodgement recesses 220, such that the locking pin 200 can move downwardly passing between the locking protrusions 320. Consequently, the locking pin 200 can be fitted to the mounting bracket 300.

That is, when the locking pin 200 is rotated to the predetermined angle such that none of the dislodgement recesses 220 is caught by the locking protrusions 320, the locking pin 200 can be fitted to or detached from the mounting bracket 300. Accordingly, the rear seat back frame 100 can be more easily fitted to or detached from the vehicle body 400, thereby improving the convenience of assembling the rear seat back.

In addition, after the locking pin 200 is fitted to the mounting bracket 300, the locking pin 200 is rotated to and left at an angle at which the locking protrusions 320 are misaligned with the dislodgement recesses 220, whereby the locking pin 200 is prevented from dislodging from the mounting bracket 300.

Meanwhile, the locking protrusions 320 protrude from the inner surfaces of the mounting bracket 300. A fitting recess 340 is formed under the locking protrusions 320 such that the locking pin 200 can be fitted into the fitting recess 340. The fitting recess 340 has a size allowing the locking pin 200 to be fitted into the fitting recess 340 with the outer circumference of the locking pin 200 being in surface contact with the fitting recess 340. The dislodgement recesses 220 may be shaped such that the dislodgement recesses 220 are cut in the outer circumferential surfaces of the locking pin 200.

That is, when the locking pin 200 is inserted into the mounting bracket 300, the locking pin 200 passes between the locking protrusions 320 and subsequently is fitted into the fitting recess 340 formed under the locking protrusions 320. Here, the outer diameter of the locking pin 200 is equal to or greater than the inner diameter of the fitting recess 340 such that the locking pin 200 is fitted into the fitting recess 340 by surface contact. This feature prevents the locking pin 200 from being loosely fitted into the fitting recess 340.

In addition, an engagement recess 330 is formed in the inner portion of the mounting bracket 300, and an engagement flange 230 is formed on the distal end of the locking pin 200, the engagement flange 230 being configured to engage with the engagement recess 330. That is, the engagement flange 230 formed on the distal end of the locking pin 200 engages into the engagement recess 330 formed in the mounting bracket 300, whereby the locking pin 200 is prevented from being separated from the mounting bracket 300 in the axial direction thereof.

The locking pin 200 further includes a mounting bush 210 fitted thereon. The mounting bush 210 is positioned between the rear seat back frame 100 and the mounting bracket 300. The mounting bush 210 serves to inhibit or prevent the rotation of the locking pin 200 from being obstructed by the friction between the mounting bracket 300 and the rear seat back frame 100.

In the device for assembling a rear seat back assembly according to the present disclosure illustrated in FIGS. 4 and 5 as described above, when the locking pin 200 fixed to the rear seat back frame 100 is fitted into the mounting bracket 300 in the top-to-bottom direction, the locking pin 200 moves downwardly by passing between the locking protrusions 320 when the dislodgement recesses are aligned with the locking protrusions 320 due to the angle at which the locking pin 200 is inserted. Consequently, the locking pin 200 is fitted to the mounting bracket 300.

The operation of rotating the locking pin 200 to the predetermined angle of rotation as described above allows the rear seat back frame 100 to be fitted to and detached from the vehicle body 400 in an easier and simpler manner, thereby improving the convenience of assembling the rear seat back.

When the dislodgement recesses 220 are misaligned with the locking protrusions 320 due to the angle at which the locking pin 200 is inserted and consequently the locking pin 200 is caught by the locking protrusions 320, the locking pin 200 cannot pass between the locking protrusions 320. In this case, the locking pin 200 cannot be fitted to the mounting bracket 300. In contrast, in the position where the locking pin 200 is fitted into the fitting recess 340, this feature prevents the locking pin 200 from dislodging from the mounting bracket 300.

Although the exemplary embodiments of the present disclosure have been described for illustrative purposes, those skilled in the art will appreciate that various modifications, additions and substitutions are possible, without departing from the scope and spirit of the present.

What is claimed is:

1. A device for assembling a rear seat back assembly in a vehicle body, the device comprising:
a mounting bracket coupled to the vehicle body and having an opening in a side portion thereof and a locking protrusion formed on an inner portion thereof; and
a locking pin protruding from a rear seat back frame,
wherein the locking pin comprises a dislodgement recess on an outer circumferential surface thereof, and the dislodgement recess passes by the locking protrusion when the locking pin is fitted to or detached from the mounting bracket.

2. The device according to claim 1, wherein the locking protrusion protrudes from the inner portion of the mounting bracket, and a fitting recess is formed under the locking protrusion such that the locking pin is fitted into the fitting recess, the fitting recess being in surface contact with the outer circumferential surface of the locking pin.

3. The device according to claim 1, wherein the dislodgement recess is formed in a cut shape on the outer circumferential surface of the locking pin.

4. The device according to claim 1, wherein the mounting bracket comprises an engagement recess formed in an inner portion, and the locking pin comprises an engagement flange on a distal end thereof, the engagement flange configured to engage with the engagement recess.

5. The device according to claim 1, further comprising a mounting bush fitted on the locking pin, the mounting bush being disposed between the rear seat back frame and the mounting bracket.

6. A device for assembling a rear seat back assembly having a rear seat back frame, the device comprising:
a mounting bracket comprising,
an opening in a side portion of the mounting bracket,
a locking protrusion inwardly protruding from an inner surface of a central portion of the mounting bracket, and
an engagement recess formed in an inner portion of the mounting bracket, the inner portion next to the central portion; and
a locking pin protruding from the rear seat back frame, an end of the locking pin forming an engagement flange configured to engage with the engagement recess,
wherein the locking pin comprises a dislodgement recess on an outer circumferential surface thereof, and the dislodgement recess is sized and structured to pass by the locking protrusion when the dislodgment recess is aligned with the locking protrusion at a predetermined position, and the locking pin is caught by the locking protrusion when the dislodgment recess is not aligned at the predetermined position.
